(19) United States
(12) Patent Application Publication
(10) Pub. No.: US 2015/0323458 A1
(43) Pub. Date: Nov. 12, 2015

(54) NONCONTACT RAPID DEFECT DETECTION OF BARRIER FILMS

(71) Applicant: Konica Minolta Laboratory U.S.A. Inc., San Mateo, CA (US)

(72) Inventor: Jun Amano, Hillsborough, CA (US)

(73) Assignee: Konica Minolta Laboratory U.S.A. Inc., San Mateo, CA (US)

(21) Appl. No.: 14/421,742

(22) PCT Filed: Sep. 26, 2013
(86) PCT No.: PCT/US2013/062038

§ 371 Date: Feb. 13, 2015

Related U.S. Application Data
(60) Provisional application No. 61/706,417, filed on Sep. 27, 2012.

(51) Int. Cl. G01N 21/64; G01N 21/84; G01N 21/88

(52) U.S. Cl. CPC G01N 21/645; G01N 21/8806; G01N 21/8422; G01N 2201/06113

(57) ABSTRACT

A method of detecting a defect in a barrier film. The method includes: coating the barrier film with a solution having a plurality of probes, where each of the probes has a nanoparticle; forcing a probe of the plurality of probes to penetrate the defect by applying a field to the barrier film, where the field induces an attractive power to the nanoparticles of the probes; applying an optical excitation (OE) to the barrier film; and identifying the defect in the barrier film based on an optical signal emitted, in response to the OE, by the probe forced to penetrate the defect.

### BACKGROUND

The lifetime of flexible electronic and optical devices made from organic materials may be highly dependent on the quality of the moisture barrier films. Although it is now possible to fabricate many different kinds of flexible electronic products, such as displays or solar cells, in order for such flexible electronic products to be commercially successful, they must also be robust enough to survive for the necessary time and conditions required of the devices. Such conditions have been a limitation of many flexible electronics. For example, OLED displays and organic solar cells require the use of low work function metal cathodes, which are extremely sensitive to water, oxygen, and a variety of other materials. In order to fabricate organic electronics on plastic substrates, a rigorous barrier film may be required.

The permeation rate of water through the high quality barrier must meet the specified requirements. For example, the water vapor transmission rate (WVTR) should be less than 10⁻⁶ g/m²/day and the oxygen transmission rate (OTR) should be less than 10⁻³ cm³/m²/day for an organic light emitting diode (OLED).

The barrier must be resistant to any processes, e.g., printing, lithography, that are carried out on it during the fabrication of the OLED devices. Quality of the barrier films is dependent on quantity and nature of defects in the films.

Recently developed fluorescent tags have been used for defect detection in the high quality barrier films, but only for very thin barriers. Moreover, this is a slow defect detection process. For example, lipophilic fluorescent substances have been used to detect surface defects in hydrophilic coatings on a hydrophobic material, as in U.S. Patent Publication No. 2010/0291685 by Zhang. Lipophilic substances are typically hydrophobic compounds or substances that tend to be non-polar and are not considered water soluble. Lipophilic substances tend to dissolve in non-polar solvents and have no affinity for hydrophilic surfaces. The specific lipophilic, fluorescent substances used in Zhang are selected to induce binding between the lipophilic fluorescent substance and the underlying hydrophobic material. The specific lipophilic, fluorescent substance fills in the defect, allowing for visualization of the defect by optical means.

In “Fluorescent Tags to Visualize Defects in Al₂O₃ Thin Films Grown Using Atomic Layer Deposition” by Zhang, et al. (Thin Solid Films 517, 6794-6797 (2009)) lipophilic molecules have been used to detect defects as small as 200 nm in a 25 nm thick hydrophobic Al₂O₃ layer. However, such techniques may require the fluorescent tags to chemically bind to the underlying hydrophobic, polymer substrate to function. It took at least 5 minutes to soak the barrier film into the fluorescent tag solution in order for the tags to be penetrated and trapped by the defects.

To date, there are no simple and noncontact methods for rapidly detecting defects in barrier films during deposition in a stationary and/or roll-to-roll process. Conventional direct defect observation methods are inefficient and slow. Gas permeation measurements are time-consuming and do not provide information on defect locations.

It is highly desirable to deposit the high quality barrier film by a wide area roll-to-roll process and to detect any defects in the films by a noncontact rapid in-situ characterization method including defect imaging in order to fabricate the flexible electronic and optical devices in a more economic manner.

The following reference(s) may have subject matter that is related to the subject matter of the claimed invention: “Fluorescent Tags to Visualize Defects in Al₂O₃ Thin Films Grown Using Atomic Layer Deposition” by Zhang, et al. (Thin Solid Films 517, 6794-6797 (2009)); US Patent Publication No. 2010/0291685 entitled: “Methods for Detecting Defects in Inorganic-Coated Polymer Surfaces”; “Fluorophore-Conjugated Iron Oxide Nanoparticle Labeling and Analysis of Engrafting Human Hematopoietic Stem Cells” Dustin J. Maxwell et al., STEM CELLS, Volume 26, Issue 2, pages 517-524, February 2008; “Bifunctional nanoparticles with superparamagnetic and luminescence properties” Fangming Zhan and Chun-yang Zhang; Dynalene Inc. 5250 West Coplay Road Whitehall, Pa. 18052. Dynalene manufactures cationic and anionic nanoparticles of various sizes ranging from 50 to 500 nm. The surface charge density ranges from 50 to 1000 micro-equivalents per gram. These ionic nanoparticles are used in water treatment, biomedical, biosensors, coatings, paper and pulp, and ink.

### SUMMARY OF INVENTION

In general, in one aspect, the invention relates to a method of detecting a defect in a barrier film. The method comprises: coating the barrier film with a solution comprising a plurality of probes, wherein each of the probes includes a nanoparticle; forcing a probe of the plurality of probes to penetrate the defect by applying a field to the barrier film, wherein the field induces an attractive power to the nanoparticles of the probes; applying an optical excitation (OE) to the barrier film; and identifying the defect in the barrier film based on an optical signal emitted, in response to the OE, by the probe forced to penetrate the defect.

In general, in one aspect, the invention relates to a system for detecting a defect in a barrier film. The system comprises: a solution comprising a plurality of probes for coating the barrier film, wherein each of the probes includes a nanoparticle; a field generator configured to force a probe of the plurality of probes to penetrate the defect by applying a field to the barrier film, wherein the field induces an attractive power to the nanoparticles of the probes; a light source configured to apply an optical excitation (OE) to the barrier film; and an optical detector for detecting an optical signal emitted, in response to the OE, by the probe forced to penetrate the defect.

Other aspects of the invention will be apparent from the following description and the appended claims.

### BRIEF DESCRIPTION OF DRAWINGS

FIG. 1A, FIG. 1B, and FIG. 1C show schematics in accordance with one or more embodiments of the invention.

FIG. 2 shows a flowchart in accordance with one or more embodiments of the invention.

FIG. 3 shows schematics in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention relate to a system and method for noncontact rapid detection and imaging of defects in a high quality barrier film. More specifically, one or more embodiments of the invention use an optically active defect probe to identify defects in a barrier film.

In one or more embodiments of the invention, an external magnetic or electric field is applied to force the optically active defect probe to rapidly penetrate into a defect in the barrier film. For example, in one or more embodiments of the invention, a magnetic nanoparticle may be conjugated with a fluorescent entity to be used as the defect probe. Accordingly, an applied magnetic field may force the defect probe to rapidly penetrate the defect. Similarly, an ionic nanoparticle may be used instead of the magnetic particle and an applied electric field may be used. In any event the applied field may induce an attractive power or force to the nanoparticles of the defect probes.

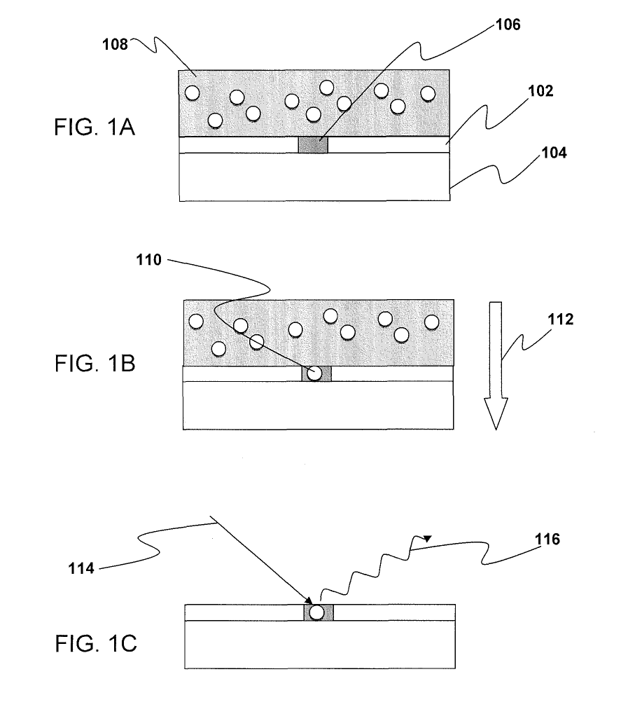

FIG. 1A shows a barrier film (102) coated onto a substrate (104) in accordance with one or more embodiments of the invention. A defect (106) exists in the barrier film (102). The barrier film is submerged in and/or coated with a solution of defect probes (108) for a predetermined amount of time. One of ordinary skill will appreciate that the structure, size, concentration of the individual probes, and exposure time are selected in conjunction to optimize the sensitivity of detection, as well has the time needed to quantify any defects.

In addition, as shown in FIG. 1B, an electric or magnetic field (112) may be applied to force the individual probes (110) to rapidly penetrate the defect (106) in the barrier film (102). In one or more embodiments of the invention, the field type and strength are selected based on the specific defect probe (110) and properties of the defect probe solution (108) used. For example, if the defect probe (110) includes a magnetic entity, a magnetic field may be used.

After the predetermined amount of time, the barrier film (102) and substrate (104) may be removed from the solution of defect probes (108), and/or the remaining defect probe solution (108) may be washed off from the surface of the barrier film (102). In accordance with one or more embodiments of the claimed invention, one or more defect probes (110) may have penetrated the defect (106) and remain in the defect (106) even after the defect probe solution (108) is washed off.

In accordance with embodiments of the invention, as shown in FIG. 1C, the barrier film (102) is excited with an optical excitation (114) applied/emitted by a light source (not shown) (e.g., laser, UV lamp, etc.). The optical excitation (114) (and thus light source) is selected based on the defect probe (110) to result in an optical signal (116). In other words, the probe (110), having previously penetrated the defect (106), emits the optical signal (116) in response to the applied optical excitation (114). The optical signal (116) is used to identify aspects of the defect (106), such as size and/or location of the defect (106). A portion of the substrate (104) and barrier film (102) having the defect (106) may then be cut out or removed from the remaining substrate (104) and barrier film (102). Alternatively, the portion having the defect (106) may simply be tagged as defective and/or omitted from any further processing.

In one or more embodiments of the invention, the defect probe may include a magnetic nanoparticle conjugated with a fluorescent molecule. Similarly, the defect probe may include a magnetic/luminescent bi-functional molecule, such as CdS—FePt or Fe₃O₄CdTeSiO₂ conjugated with a fluorescent molecule. In these embodiments, a magnetic field may be applied to force the defect probe to rapidly penetrate the defect. The magnetic field may be applied using one or more permanent magnets or one or more electromagnets. In embodiments where a variable magnetic field is desirable, one or more electromagnets may be preferred.

In one or more embodiments of the invention, the defect probe may include an ionic nanoparticle. The ionic nanoparticle may be conjugated with a fluorescent molecule. Anionic and cationic nanoparticles have been utilized in biomedical, biosensing, and other types of applications. In these embodiments, an electric field may be applied to force the defect probe to rapidly penetrate the defect. The electric field may be applied by any number of known techniques.

The optical excitation and detection of the optical signal may be achieved through various techniques known in the art. For example, in one or more embodiments of the invention, a commercial fluorometer may be used to supply the optical excitation and measure the optical signal emitted by the probe(s).

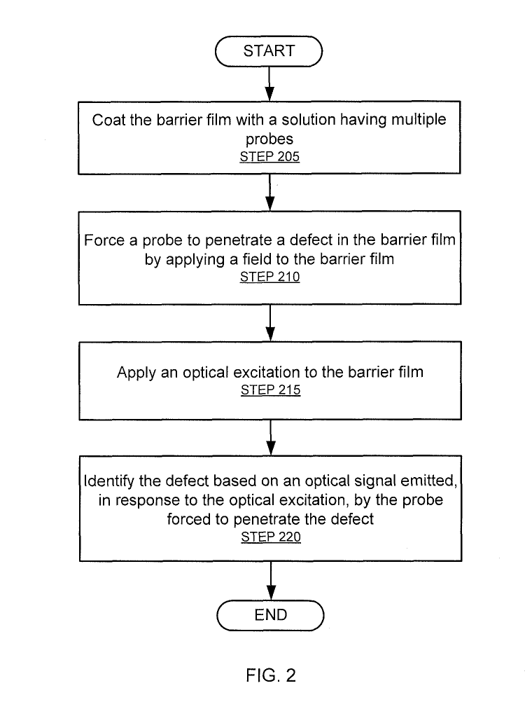

FIG. 2 shows a flowchart in accordance with one or more embodiments of the invention. The process shown in FIG. 2 may be executed, for example, using one or more components discussed above in reference to FIG. 1A, FIG. 1B, and/or FIG. 1C. One or more steps shown in FIG. 2 may be omitted, repeated, and/or performed in a different order among different embodiments of the invention. Accordingly, embodiments of the invention should not be considered limited to the specific number and arrangement of steps shown in FIG. 2.

In STEP 205, a barrier film is coated with a solution of probes for a predetermined period of time. In one or more embodiments of the invention, the barrier film (and its corresponding substrate) are submerged in the solution. In one or more embodiments, the barrier film may be stored/contained on a roll to roll system with the barrier film passing through the solution of probes.

In STEP 210, the probes are forced into the defects by applying a field to the barrier film while the barrier film is in the solution (or at least coated with the solution). The field induces/forces the probes to rapidly penetrate any defects in the barrier film. A probe penetrating a defect may include: (i) the probe entering the defect but not attaching to the defect; (ii) the probe attaching to the defect after the probe has entered the defect; and/or (iii) the probe attaching to an opening edge of the defect. As noted previously, the field may be a magnetic or electric field depending on the specific probe used. The strength of the field is determined in conjunction with the specific probe selected, concentration of probes in solution, and the predetermined amount of time the barrier film is exposed to the solution of probes.

In STEP 215, the barrier film is removed from the solution of probes, and/or the remaining defect probe solution is washed off from the surface of the barrier film, and an optical excitation is applied to the barrier film. The choice of optical excitation (and thus the light source applying/emitting the optical excitation) is based on the selected probe.

In STEP 220, the defect is identified based on an optical signal emitted by the probe. In one or more embodiments of the invention, the optical signal is a fluorescent response associated with the probe. One of ordinary skill in the art will appreciate that embodiments of the invention are not limited to fluorescence. For example, the probe may have an optical absorption and/or scattering cross-section that may be detected by optical means other than fluorescence. The above techniques are not limited to the visible range of the electromagnetic spectrum, and may include the ultraviolet and/or infrared regions of the electromagnetic spectrum.

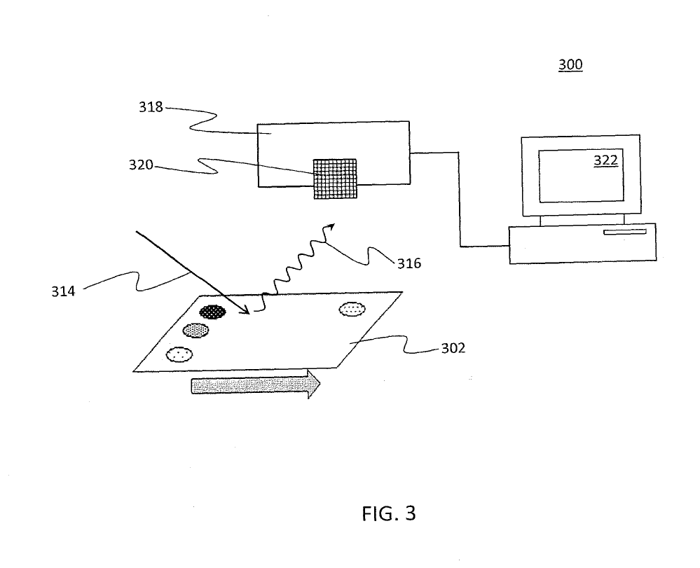

FIG. 3 is a schematic of a system (300) for detecting the defects in accordance with one or more embodiments of the claimed invention. In FIG. 3, the horizontal arrow indicates the direction that the barrier film (302) moves through the system (300) during the defect detecting process in accordance with one or more embodiments of the invention. The barrier film (302) is coated with or moves through the solution of probes for the predetermined period of time. While exposed to the solution of probes, the field is applied to induce/force the probes to rapidly penetrate the defects in the barrier film in accordance with one or more embodiments of the invention. The barrier film then continues moving at a specified rate as demonstrated in FIG. 3. While moving, the optical excitation (314) is applied, and the resultant emission (316) may be detected by CMOS image sensor (318) that may also include an detection array (320). The image sensor (318) is connected to a computer or monitoring device (322). The monitoring device may quantify the emission (316) and detect the defects in the barrier film (302). The monitoring device may display or print images of the emission (316) from the barrier film (302). The image data from the horizontal pixels in the array (320) may be synchronously accumulated to improve the signal to noise ratio as the barrier film (302) moves through the system (300).

In one or more embodiments of the invention, the identified defect in the barrier film may be removed from the rest of the barrier film. In one or more embodiments of the invention, the portion of the barrier film having the defect is tagged and excluded from any further processing. Alternatively, the characteristics of the defect, such as location and size, may be used to modify one or more future steps in a manufacturing process.

Advantageously, embodiments of the invention may contribute to a significant cost reduction by eliminating defective sections in high quality barrier films, prior to the manufacturing of final products, and/or prior to shipping the high quality barrier films to third parties (e.g., customers) for additional processing.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of detecting a defect in a barrier film, comprising:
coating the barrier film with a solution comprising a plurality of probes, wherein each of the probes comprises a nanoparticle;
forcing a probe of the plurality of probes to penetrate the defect by applying a field to the barrier film, wherein the field induces an attractive power to the nanoparticles of the probes;
applying an optical excitation (OE) to the barrier film; and
identifying the defect in the barrier film based on an optical signal emitted, in response to the OE, by the probe forced to penetrate the defect.

2. The method of claim 1, further comprising:
removing a portion of the barrier film comprising the defect.

3. The method according to claim 1, wherein the probe further comprises a fluorescent entity.

4. The method of claim 3, wherein the fluorescent entity is a quantum dot.

5. The method of claim 3, wherein the fluorescent entity is a fluorescent molecule.

6. The method of claim 1, wherein the nanoparticle is conjugated with a fluorescent molecule.

7. The method of claim 1, wherein the probe is a bi-functional nanoparticle.

8. The method of claim 1, wherein the field is magnetic.

9. The method of claim 1, further comprising:
generating the OE using a laser, wherein the OE and the optical signal are in a visible range of the electromagnetic spectrum.

10. A system for detecting a defect in a barrier film, comprising:
a solution comprising a plurality of probes for coating the barrier film, wherein each of the probes comprises a nanoparticle;
a field generator configured to force a probe of the plurality of probes to penetrate the defect by applying a field to the barrier film, wherein the field induces an attractive power to the nanoparticles of the probes;
a light source configured to apply an optical excitation (OE) to the barrier film; and
an optical detector for detecting an optical signal emitted, in response to the OE, by the probe forced to penetrate the defect.

11. The system according to claim 10, wherein the probe further comprises a fluorescent entity.

12. The system of claim 11, wherein the fluorescent entity is a quantum dot.

13. The system of claim 11, wherein the fluorescent entity is a fluorescent molecule.

14. The system of claim 10, wherein the nanoparticle is conjugated with a fluorescent molecule.

15. The system of claim 10, wherein the probe is a bi-functional nanoparticle.
